(19) United States
(12) Patent Application Publication
(10) Pub. No.: US 2009/0026324 A1
(43) Pub. Date: Jan. 29, 2009

(54) BLOCK LINER

(76) Inventors: Calvin G. Hensley, East Flat Rock, NC (US); Coy G. Hensley, Hendersonville, NC (US)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 11/781,583

(22) Filed: Jul. 23, 2007

(51) Int. Cl. F16L 3/08

(52) U.S. Cl. 248/65; 137/15.08

(57) ABSTRACT

A block liner for enclosing hoses, wires, cables and the like of an HVAC system being run through masonry unit includes a hollow cylindrical tube having an interior surface and an exterior surface, a first open end a second open end, and a flange positioned proximate the second end of the tube for attaching to a wall structure. The tube is tapered beginning on the interior surface of the tube and terminating on the outer surface at the first end of the tube. The block liner can be made molded from plastic or other suitable material.

### TECHNICAL FIELD AND BACKGROUND OF THE INVENTION

The invention relates to an apparatus for covering hoses, cables, wires and the like, and a method of using same. A particular embodiment of the invention includes a block liner for use with heating-ventilation-air conditioning (HVAC) systems having a tubular sleeve that can be positioned over the exterior of wires, cables, hoses, etc. connected to the HVAC system.

Installation of HVAC systems in commercial and residential buildings typically requires hoses, wires, cables and the like to be run from the interior of the building to the building exterior. This typically requires the hoses, wires and cables to be run through a wall of the building, which is often comprised of concrete blocks, bricks, steel, wood, etc.

If the hoses, wires and cables are run through the wall without any protective enclosure, direct contact and rubbing of the hoses, wires and cables against the cinder block wall can lead to fraying of the hoses, sires and cables. Therefore, block liners have been developed to provide a protective enclosure for such hoses, wires and cables being run through the wall of a building. However, the hoses, wires and cables often frictionally engage the interior of the block liner making it difficult to move the hoses, wires and cables through. As such, an apparatus providing a protective enclosure for such hoses, wires and cables and also facilitates their movement therethrough would be desirable.

### SUMMARY OF THE INVENTION

Therefore it is an object of the present invention to provide a protective enclosure for hoses, wires, cables and the like running through a wall of a building.

Another object of the present invention is to provide an apparatus for covering hoses, wires, cables and the like extending through a building wall that facilitates movement of the hoses, wires and cables therethrough.

These and other objectives of the present invention are achieved in the preferred embodiments disclosed below. One embodiment of the invention includes an apparatus for containing at least one elongate member comprising a tube having an interior surface and an exterior surface, a first open end a second open end, and a flange positioned proximate the second end of the tube for attaching to a wall structure. The tube includes a first taper beginning on the interior surface of the tube and terminating on the outer surface at the first end of the tube.

According to another preferred embodiment of the invention, the tube has a second taper beginning on the interior surface of the tube and terminating on the outer surface at the second end of the tube.

According to another preferred embodiment of the invention, the flange has a plurality of openings for inserting a fastener therethrough.

According to yet another preferred embodiment of the invention, the tube is cylindrical.

According to yet another preferred embodiment of the invention, the elongate member is a hose, wire and/or cable connected to an HVAC system.

According to yet another preferred embodiment of the invention, the block liner includes an extension member adapted for complementary engagement with the tube.

According to yet another preferred embodiment of the invention, the extension member has an interior surface and an exterior surface, and a first open end and a second open end. The extension member has a taper beginning on the interior surface of the extension member and terminating on the outer surface at the first end of the extension member.

According to yet another preferred embodiment of the invention, the tube has a cylindrical body, and the extension member also has a cylindrical body having a first open end and a second open end, and a diameter about equal to the diameter of the tube's cylindrical body. An enlarged section is positioned at the second end of the cylindrical body of the extension member and has a diameter larger than the cylindrical bodies of the tube and extension members such that the extension member provides a nesting area for receiving the first end of the tube.

According to yet another preferred embodiment of the invention, cylindrical body of the extension member has an outer surface and an interior surface, and a taper beginning on the interior surface and terminating on the outer surface at the first end of the cylindrical body.

According to yet another preferred embodiment of the invention, a block liner for use in a masonry block includes a hollow cylindrical body having an interior surface and an exterior surface, and a first open end and a second open end. A flange section can be positioned proximate the second end of the body for mounting to a wall structure. The cylindrical body includes a first taper beginning on the interior surface of the body and terminating proximate the first end of the body.

According to yet another preferred embodiment of the invention, the cylindrical body and the flange section are made of plastic.

According to yet another preferred embodiment of the invention, the cylindrical body and flange section are injection molded.

A preferred embodiment of a method of using the block liner in conjunction with hoses of a heating-ventilation-air conditioning system through a masonry block includes providing a block liner having a hollow cylindrical body with an interior surface and an exterior surface, and a first open end defining an interior opening and a second open end defining an exterior opening. A flange section is positioned proximate the second end of the body, and the cylindrical body has a first taper beginning on the interior surface of the body and terminating at the first end of the body. The hoses are run through the interior opening into the cylindrical body and out through the exterior opening.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a perspective view of a block liner according to a preferred embodiment of the invention;

FIG. 2 is a cross sectional view of the block liner of FIG. 1; and

FIG. 3 is a schematic perspective view of a block liner according to another preferred embodiment of the invention;

FIG. 4 is another perspective view of the block liner of FIG. 3;

FIG. 4 is another perspective view of the block liner of FIG. 3;

FIG. 5 is a cross sectional view of the block liner of FIG. 3 taken along line 5 in FIG. 3;

FIG. 6 is another cross sectional view of the block liner of FIG. 3 taken along line 6 in FIG. 4;

FIG. 7 is a side elevation of an extension member according to a preferred embodiment of the invention;

FIG. 8 is a side elevation of the block liner of FIG. 1;

FIG. 9 is a cross sectional view of the extension member of FIG. 7;

FIG. 10 is a cross sectional side elevation of the block liner of FIG. 1;

FIG. 11 is a top plan view of the block liner of FIG. 1;

FIGS. 12-13 are environmental perspective views of the block liner of FIG. 1;

FIG. 14 is an environmental perspective view of the block liner of FIG. 3;

FIG. 15 is a cross sectional environmental view of the block liner of FIG. 3; and

FIG. 16 is a perspective view of a block liner according to another preferred embodiment of the invention.

### DETAILED DESCRIPTION OF THE INVENTION

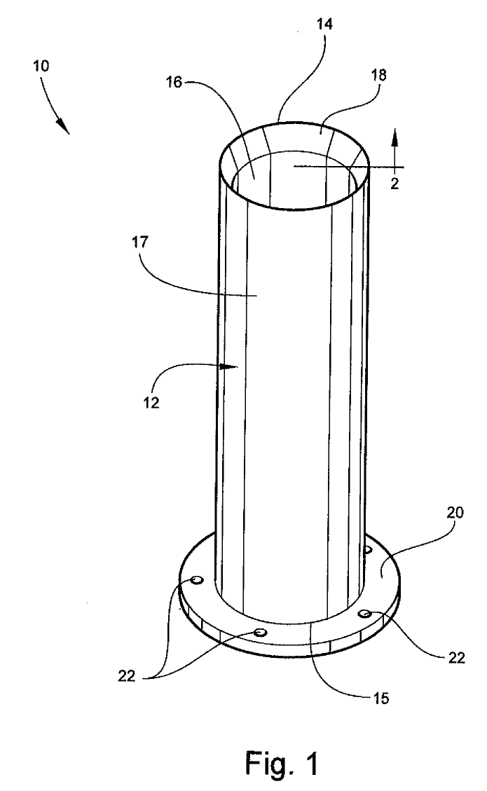

Referring now specifically to the drawings, a block liner apparatus according to a preferred embodiment of the invention is illustrated in FIG. 1, and shown generally at reference numeral 10. As shown in FIG. 1, the block liner 10 comprises a hollow cylindrical tube 12 having a first open end 14 and a second open end 15. A flange 20 is positioned at second open end 15 of the tube 12, and has a plurality of openings 22. The tube 12 and flange 20 can be made of plastic or other suitable material. The flange 20 is integrally molded on the tube 127 or alternatively, can be a separate piece mounted on the tube 12 by any suitable attachment means such as with an adhesive or mechanical fasteners.

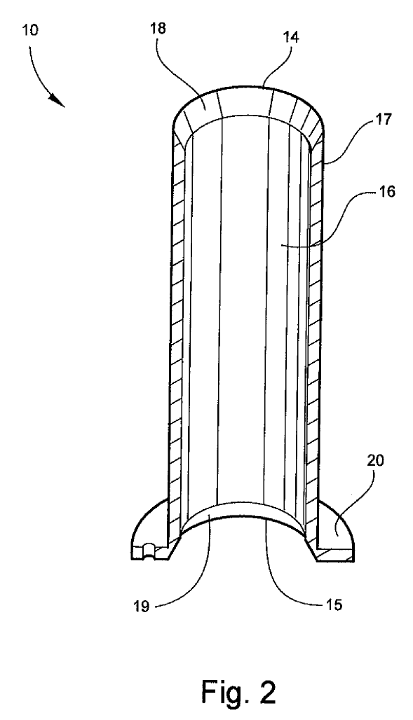

The tube 12 has an interior surface 16 and an exterior surface 17. As shown in FIG. 2, the tube 12 is tapered at the first open end 14 and the second open end 15. A first taper 18 begins on the interior surface 16 of the tube and terminates at the exterior surface 17 at the first end 14. As such, the exterior surface 17 of the tube 12 extends beyond the interior surface 16 of the tube 12. A second taper 19 begins on the interior surface 16 of the tube and terminates at the exterior surface 18 at the second end 15 of the tube 12.

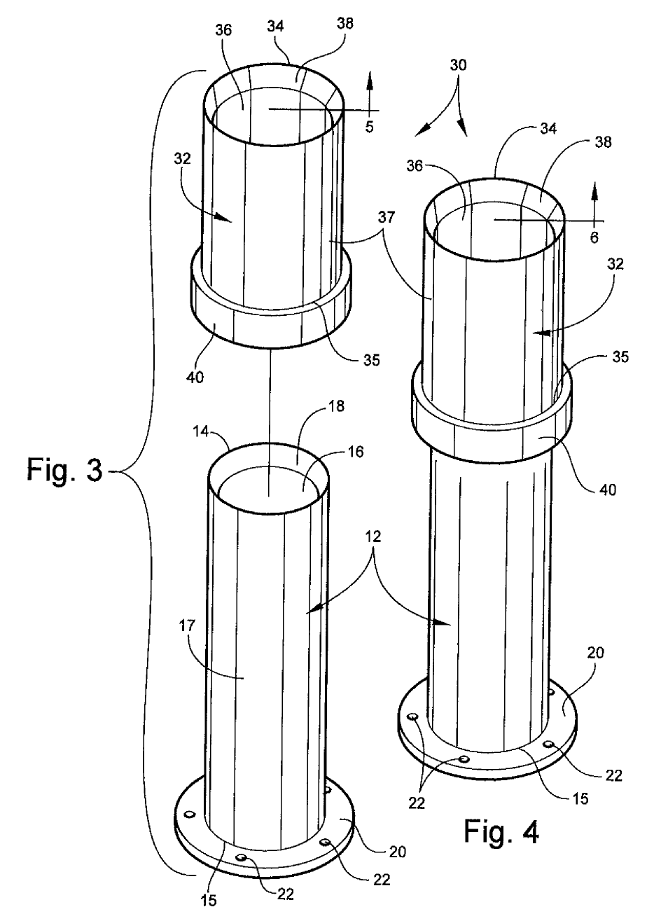

As shown in FIGS. 3 and 4, an extension tube 30 can be removably attached to the tube 12 to increase the total length of the block liner 10. The extension tube 30 includes a hollow cylindrical body section 32 having a diameter substantially equal to the diameter of the tube 12. The cylindrical body section 32 has a first open end 34 and a second open end 35, and an interior surface 36 and exterior surface 37. The extension tube 30 has a taper 38 beginning on the interior surface 36 and terminating at the exterior surface at the first open end 34.

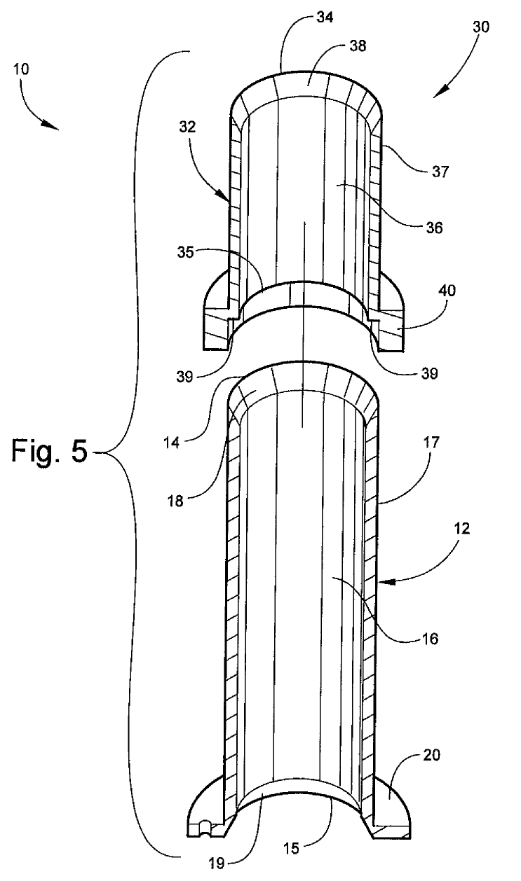

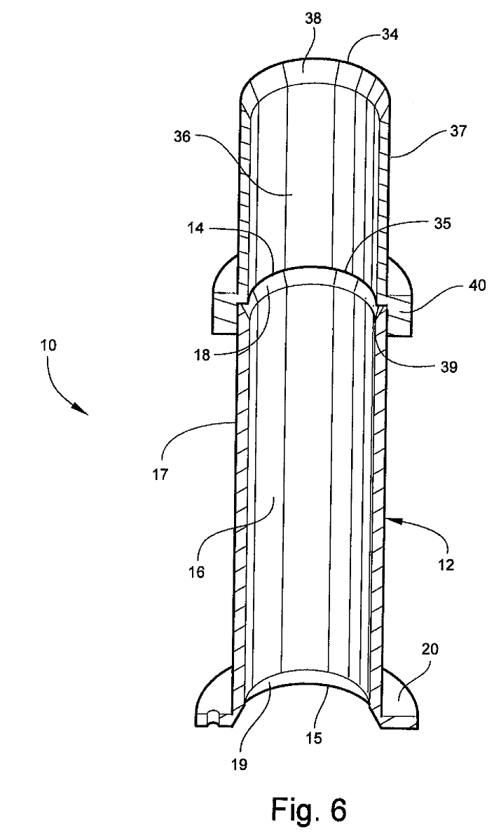

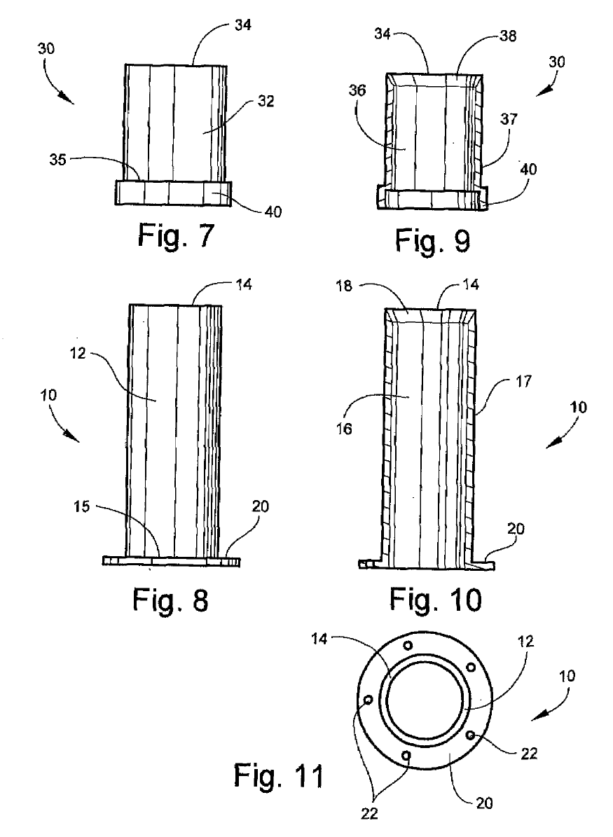

An enlarged section 40 is positioned on the second open end 35 of the cylindrical body 32, and has a diameter slightly larger than the diameter of the main tube 12 and the cylindrical body 32 of the extension tube 30. As such, the enlarged section 40 and the cylindrical body 32 form a nesting area 39 for receiving and frictionally engaging the first end 14 of the main tube 12 so that the main tube 12 can be removably attached to the extension tube 30, as shown in FIGS. 5 and 6. Additional extension tubes 30 can be utilized to further increase the length of the block liner 10.

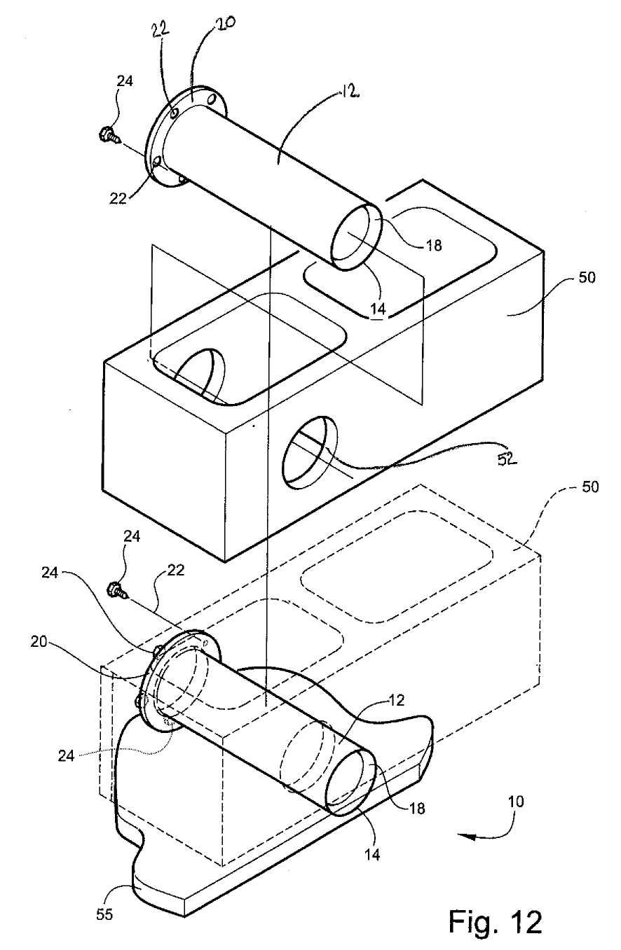

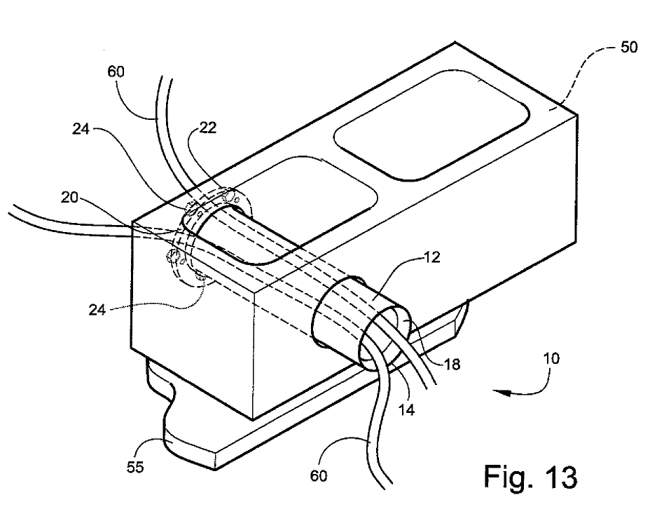

As shown in FIGS. 12-14, the block liner 10 can be used in conjunction with a wall structure comprising a masonry unit such as a concrete block 50. In particular, the block liner 10 can be used to run elongate members 60 such as hoses, wires and cables of a commercial or residential HVAC system through the concrete block 50, as shown in FIGS. 13-15.

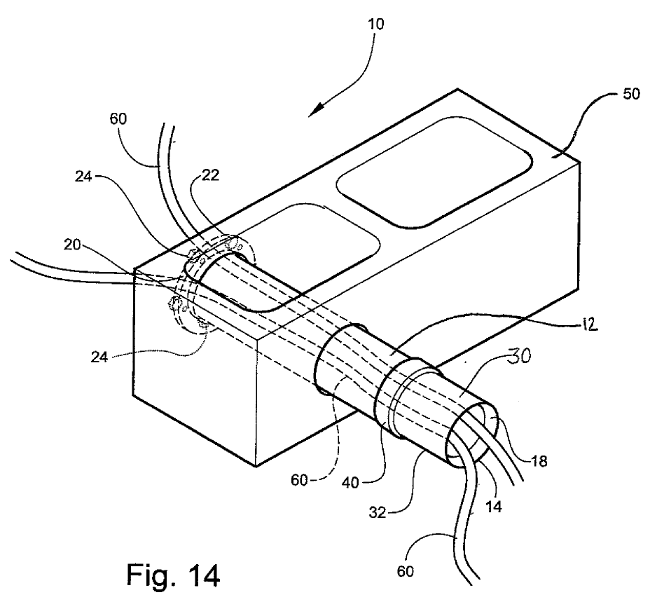

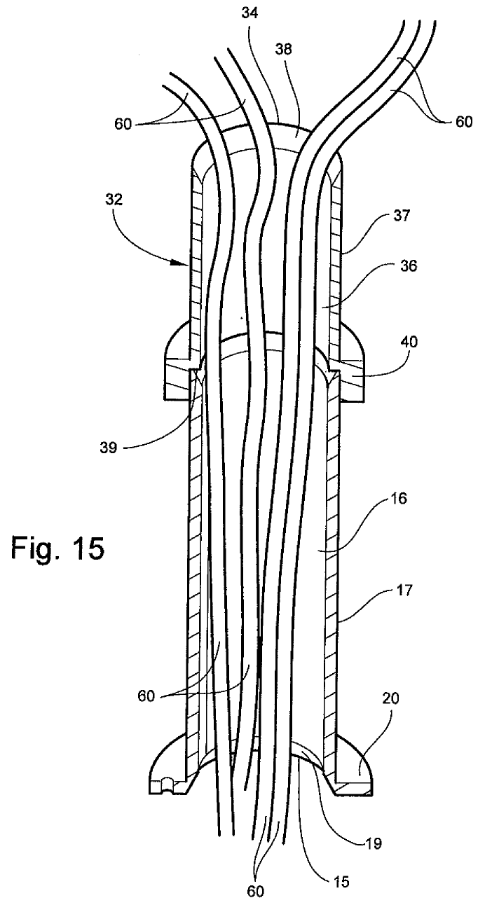

As shown in FIG. 12, the block liner 10 is positioned in an opening 52 formed in the concrete block 50 such that the flange 20 is substantially flat against a surface of the block 50. Fasteners such as screws 24 are inserted through the openings 22 of the flange 20 to attach the block liner 10 to the block 50. As shown in FIG. 13, the block liner 10 extends through the opening 52 in the concrete block 50, and the hoses, wires and/or cables 60 are run through the second open end 15 of the block liner 10 through the interior of the tube 12 and out the first open end 14. The tapered area 19 facilitates movement of the hoses, wires and/or cables 60 into the second open end 15, and likewise the tapered area 18 facilitates movement of the hoses, wires and/or cables 60 out the first open end 14. FIGS. 14 and 15 illustrate the same process utilizing the block liner 10 with an extension tube 30. As shown in FIG. 15, the tapered areas 18, 19, 38 of the block liner 10 facilitate movement of hoses, cables and/or wires 60 through the interior of the block liner 10, and helps prevent the scuffing of the wires, cables and/or hoses 60 when being pulled through the liner 10.

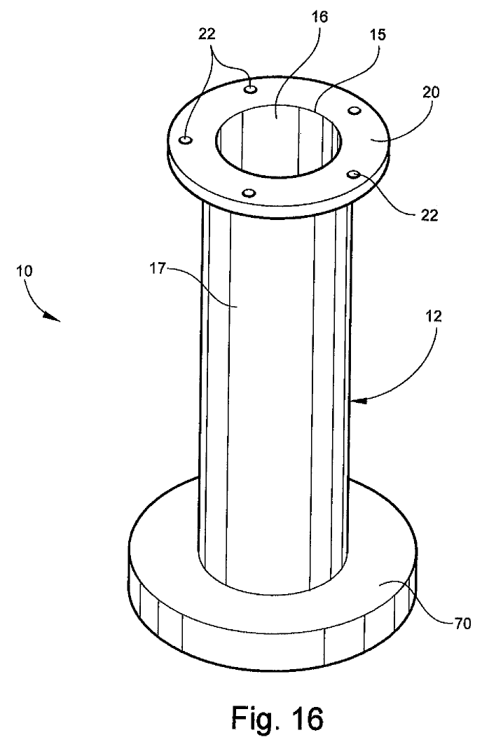

FIG. 16 illustrates the block liner 10 with a locking member 70 connected at the first end 14 of the tube 12. Locking member 70 has a female fitting for sliding over and mating with 8 or 12 inch male piping.

It should be noted that the block liner 10 can be used in applications other than HVAC systems, such as running copper lines of commercial or residential refrigerators. Also, the block liner 10 can be used in conjunction with a variety of wall structures, including walls made from materials such as steel, brick, and/or wood.

A block liner apparatus and method of using same is described above. Various details of the invention may be changed without departing from its scope. Furthermore, the foregoing description of the preferred embodiments of the invention and the best mode for practicing the invention are provided for the purpose of illustration only and not for the purpose of limitation—the invention being defined by the claims.

What is claimed is:

1. An apparatus for containing at least one elongate member comprising:
(a) a tube having an interior surface and an exterior surface, and a first open end a second open end;
(b) a flange positioned proximate the second end of the tube for attaching to a wall structure; and
(c) wherein the tube includes a first taper beginning on the interior surface of the tube and terminating on the outer surface at the first end of the tube.

2. An apparatus according to claim 1, further wherein the tube includes a second taper beginning on the interior surface of the tube and terminating on the outer surface at the second end of the tube.

3. An apparatus according to claim 1, wherein the flange includes a plurality of openings for inserting a fastener therethrough.

4. An apparatus according to claim 1, wherein the tube is cylindrical.

5. An apparatus according to claim 1, wherein the elongate member comprises at least one item selected from the group consisting of a hose, a wire and a cable.

6. An apparatus according to claim 1, further comprising an extension member adapted for complementary engagement with the tube.

7. An apparatus according to claim 6, wherein the extension member has an interior surface and an exterior surface, and a first open end and a second open end, and further wherein the extension member includes a taper beginning on the interior surface of the extension member and terminating on the outer surface at the first end of the extension member.

8. An apparatus according to claim 6, wherein the tube includes a first cylindrical body having a diameter, and the extension member comprises:
(a) a second cylindrical body having a first open end and a second open end, and a diameter about equal to the diameter of the first cylindrical body; and
(b) an enlarged section positioned at the second end of the second cylindrical body having a diameter larger than the first and second cylindrical bodies whereby the second cylindrical body and the enlarged section define a nesting area for receiving the first end of the tube.

9. An apparatus according to claim 8, wherein the second cylindrical body has an outer surface and an interior surface, and a taper beginning on the interior surface of the second cylindrical body and terminating on the exterior surface at the first end of the second cylindrical body.

10. A block liner for use in a masonry block comprising:
(a) a hollow cylindrical body having an interior surface and an exterior surface, and a first open end and a second open end;
(b) a flange section positioned proximate the second end of the body for mounting to a wall structure; and
(c) wherein the cylindrical body includes a first taper beginning on the interior surface of the body and terminating proximate the first end of the body.

11. A block liner according to claim 10, wherein the cylindrical body and the flange section are made of plastic.

12. A block liner according to claim 10, wherein the cylindrical body and flange section are injection molded.

13. A method for running hoses of a heating-ventilation-air conditioning system through a masonry block comprising the steps of:
(a) providing a block liner comprising:
(i) a hollow cylindrical body having an interior surface and an exterior surface, and a first open end defining an interior opening and a second open end defining an exterior opening,
(ii) a flange section positioned proximate the second end of the body, and
(iii) wherein the cylindrical body includes a first taper beginning on the interior surface of the body and terminating at the first end of the body; and
(b) providing hoses for connecting to the heating-ventilation-air conditioning system;
(c) running the hoses through the interior opening into the cylindrical body and out through the exterior opening.
